(19) United States
(12) Patent Application Publication
(10) Pub. No.: US 2026/0290904 A1
(43) Pub. Date: Sep. 24, 2026

(54) SECONDARY BATTERY

(71) Applicant: Toyota Jidosha Kabushiki Kaisha, Toyota-shi (JP)

(72) Inventor: Takuya SUGIMOTO, Toyota-shi (JP)

(73) Assignee: Toyota Jidosha Kabushiki Kaisha, Toyota-shi (JP)

(21) Appl. No.: 19/555,205

(22) Filed: Mar. 3, 2026

(30) Foreign Application Priority Data
Mar. 21, 2025 (JP) 2025-046725

(51) Int. Cl. H01M 10/0585; H01M 10/0525

(52) U.S. Cl. CPC H01M 10/0585; H01M 10/0525

(57) ABSTRACT

A secondary battery includes a separator and a laminate in which a negative electrode composite material layer and a negative electrode collector foil are laminated on a first surface of the separator, and a positive electrode composite material layer, a positive electrode collector foil, and a resin layer are laminated on a second surface of the separator, in which an end surface of the positive electrode composite material layer is disposed inward of an end surface of the separator, an end surface of the negative electrode composite material layer, and an end surface of the resin layer, and an end surface of the positive electrode collector foil is disposed inward of the end surface of the positive electrode composite material layer.

### CROSS-REFERENCE TO RELATED APPLICATION

This application claims priority to Japanese Patent Application No. 2025-046725 filed on March 21, 2025. The disclosure of the above-identified application, including the specification, drawings, and claims, is incorporated by reference herein in its entirety.

### BACKGROUND

### Technical Field

The present disclosure relates to a secondary battery.

### Description of Related Art

In Japanese Unexamined Patent Application Publication No. 2021-170486 (JP 2021-170486 A), it is disclosed that a positive electrode collector 22A and a negative electrode collector 22B of a battery have the same size (for example, FIG. 5).

### SUMMARY

In the related art battery, foreign matter mixed in may penetrate the separator to cause a short circuit between the negative electrode composite material layer and the positive electrode collector foil, and this short circuit may cause a large-scale short circuit, which is a serious problem.

The present disclosure has been made in view of the above problem, and an object thereof is to provide a secondary battery capable of suppressing the occurrence of a large-scale short circuit.

The present application discloses a secondary battery including a laminate that includes a separator and in which a negative electrode composite material layer and a negative electrode collector foil are laminated on a first surface of the separator, and a positive electrode composite material layer, a positive electrode collector foil, and a resin layer are laminated on a second surface of the separator, in which:

an end surface of the positive electrode composite material layer is disposed inward of an end surface of the separator, an end surface of the negative electrode composite material layer, and an end surface of the resin layer; and

an end surface of the positive electrode collector foil is disposed inward of the end surface of the positive electrode composite material layer.

The laminate may be a bipolar type.

A portion of an end part of the resin layer, the portion being not laminated with the positive electrode composite material layer, may not include a conductive filler.

A distance between the end surface of the positive electrode composite material layer and the end surface of the positive electrode collector foil may be 2 mm or less.

According to the secondary battery of the present disclosure, even when foreign matter is mixed and a first end of the foreign matter penetrates the separator and reaches the negative electrode composite material layer, a second end of the foreign matter is prevented from coming into contact with the resin layer and touching the positive electrode collector foil, and the occurrence of a large-scale short circuit can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a laminated structure of a secondary battery 10;

FIG. 2 is a diagram illustrating an action of the secondary battery 10;

FIG. 3A is a diagram illustrating a test example;

FIG. 3B is a diagram illustrating the test example; and

FIG. 3C is a diagram illustrating the test example.

### DETAILED DESCRIPTION OF EMBODIMENTS

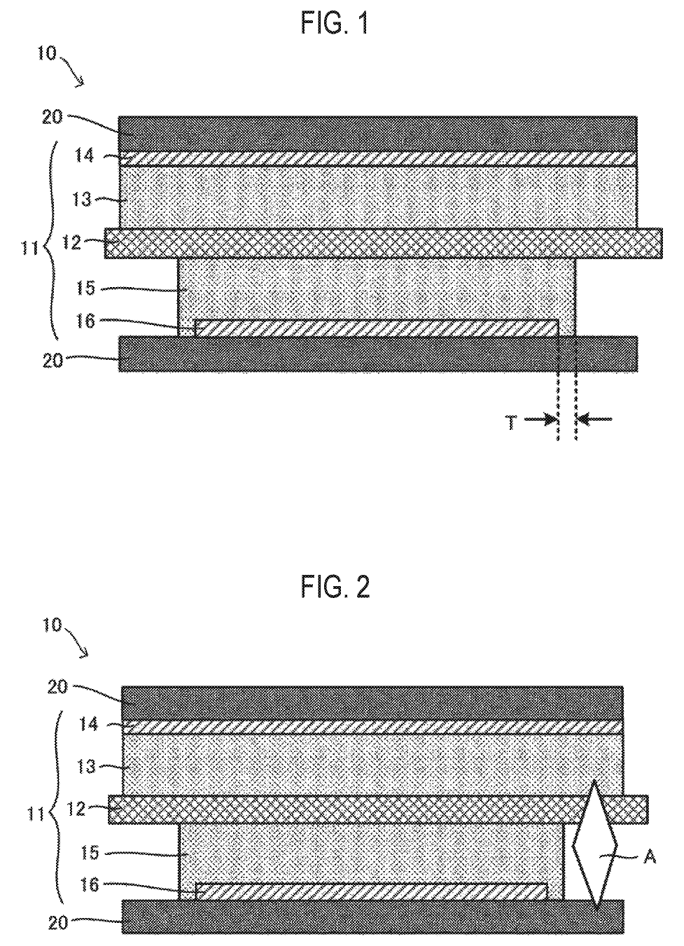

FIG. 1 schematically shows a secondary battery 10 according to one form example. FIG. 1 is a diagram illustrating a laminated structure of the secondary battery 10. In FIG. 1, for convenience of description, configurations necessary for the description are shown, and a battery case and the like are omitted. Here, the secondary battery means any of an all-solid state battery in which an electrolyte is formed of a solid electrolyte, a semi-solid state battery in which at least a part of the electrolyte is a solid electrolyte and also includes an electrolytic solution, or a battery including only an electrolytic solution. Hereinafter, the form example will be described by using the all-solid state battery. The configurations of each part in a case other than the all-solid state battery are as well known.

As can be seen from FIG. 1, the secondary battery 10 includes a unit laminate 11 and a resin layer 20 as one unit battery, and a plurality of the unit laminates 11 and the resin layers 20 are laminated to be repeated. The unit laminate 11 includes a separator 12, a negative electrode composite material layer 13 is laminated on a first surface of the separator 12, a negative electrode collector foil 14 is laminated on the negative electrode composite material layer 13, a positive electrode composite material layer 15 is laminated on a second surface of the separator 12, and a positive electrode collector foil 16 is laminated on the positive electrode composite material layer 15. Further, the resin layer 20 is laminated on the positive electrode collector foil 16. The resin layer 20 is a layer disposed between adjacent unit laminates 11.

The unit laminates 11 are sequentially laminated to sandwich the resin layer 20, thereby forming the secondary battery, and in the present form, the secondary battery is a so-called bipolar type battery.

### Separator

The separator 12 is a layer formed of polyethylene or the like and includes at least an electrolyte. In a case where the secondary battery 10 is the all-solid-state battery, the separator 12 can include a solid electrolyte and optionally a binder. An inorganic solid electrolyte described later can be applied as the solid electrolyte. A binder can be appropriately selected and used as the same as the binder used in the negative electrode composite material layer 13 described later. The materials in the separator 12 and the shape of the separator 12 may be the same as those in the related art. In particular, from the viewpoint of easily configuring the secondary battery 10, a separator 12 having a sheet shape is preferable. In this case, a thickness of the separator 12 is, for example, preferably 0.1μm to 1mm and more preferably 1μm to 100μm. Still More preferably, the thickness of the separator 12 is 1μm to 15μm.

### Negative Electrode Composite Material Layer

The negative electrode composite material layer 13 is a layer including at least a negative electrode active material. In a case where the secondary battery 10 is the all-solid-state battery, a solid electrolyte, a binder, a conductive auxiliary agent, and the like can be optionally included in addition to the negative electrode active material. A known active material may be used as the active material. Among known active materials, two materials having different potentials (charge and discharge potentials) at which predetermined ions are intercalated and deintercalated can be selected, and a material showing a higher potential can be used as a positive electrode active material described later, and a material showing a lower potential can be used as a negative electrode active material. For example, in a case of constituting a lithium-ion battery, as the negative electrode active material, a carbon material such as graphite or hard carbon, various oxides such as lithium titanate, Si or a Si alloy, or metal lithium or a lithium alloy can be used.

The solid electrolyte is preferably an inorganic solid electrolyte. The reason for the above is that the inorganic solid electrolyte has higher ionic conductivity and superior heat resistance compared to an organic polymer electrolyte. Examples of the inorganic solid electrolyte include an oxide solid electrolyte such as lanthanum zirconate lithium, and a sulfide solid electrolyte such as Li₂S-P₂S₅. In particular, a sulfide solid electrolyte including Li₂S-P₂S₅ is preferable, and a sulfide solid electrolyte including 50% by mole or more of Li₂S-P₂S₅ is more preferable.

As the binder, various binders such as butadiene rubber (BR), styrene butadiene rubber (SBR), acrylate butadiene rubber (ABR), and polyvinylidene fluoride (PVdF) can be used.

As the conductive auxiliary agent, a carbon material such as acetylene black or Ketjen black, or a metal material such as nickel, aluminum, or stainless steel can be used.

The content of each component in the negative electrode composite material layer 13 and the shape of the negative electrode composite material layer 13 may be the same as those in the related art. In particular, from the viewpoint of easily configuring the secondary battery 10, a negative electrode composite material layer having a sheet shape is preferable. In this case, a thickness of the negative electrode composite material layer 13 is, for example, preferably 0.1μm to 1mm and more preferably 1μm to 100μm. However, it is preferable that the thickness of the negative electrode composite material layer 13 is determined such that a capacity of the negative electrode is larger than a capacity of the positive electrode.

### Negative Electrode Collector Foil

The negative electrode collector foil 14 is a foil having a collecting action, which is formed of a metal foil, a metal mesh, or the like. In particular, a metal foil is preferable. Examples of the metal constituting the negative electrode collector foil 14 include Cu, Ni, Fe, Ti, Co, Zn, and stainless steel. The negative electrode collector foil 14 may have a coating layer for adjusting a contact resistance on a surface thereof. For example, the coating layer is a carbon coating. A thickness of the negative electrode collector foil 14 is not particularly limited. For example, the thickness is preferably 0.1μm to 1mm and more preferably 1μm to 100μm.

### Positive Electrode Composite Material Layer

The positive electrode composite material layer 15 is a layer including at least a positive electrode active material. In a case where the secondary battery 10 is the all-solid-state battery, a solid electrolyte, a binder, a conductive auxiliary agent, and the like can be optionally included in addition to the positive electrode active material.

A known active material may be used as the positive electrode active material. Among known active materials, two materials having different potentials (charge and discharge potentials) at which predetermined ions are intercalated and deintercalated can be selected, and a material showing a higher potential can be used as the positive electrode active material, and a material showing a lower potential can be used as the negative electrode active material. For example, in a case of constituting a lithium-ion battery, various lithium-containing complex oxides such as lithium cobalt oxide, lithium nickelate, LiNi_{1/3}Co_{1/3}Mn_{1/3}O₂, lithium manganese oxide, and a spinel-based lithium compound can be used as the positive electrode active material.

The surface of the positive electrode active material may be coated with an oxide layer such as a lithium niobate layer, a lithium titanate layer, or a lithium phosphate layer.

The solid electrolyte, the binder, and the conductive auxiliary agent can be appropriately selected and used as the same as those in the negative electrode composite material layer 13.

The content of each component in the positive electrode composite material layer 15 may be the same as that in the related art. In addition, from the viewpoint of easily configuring the secondary battery 10, a positive electrode composite material layer is preferable. In this case, a thickness of the positive electrode composite material layer 15 is, for example, preferably 0.1μm to 1mm and more preferably 1μm to 150μm.

In addition, as can be seen from FIG. 1, the positive electrode composite material layer 15 is configured such that an end surface thereof is disposedinward of the separator 12, the negative electrode composite material layer 13, and the resin layer 20.

### Positive Electrode Collector Foil

The positive electrode collector foil 16 is a conductive layer. Therefore, the positive electrode collector foil 16 is formed of a metal foil, a metal mesh, or the like. Among these, a metal foil is particularly preferable. Examples of the metal constituting the positive electrode collector foil 16 include Ni, Cr, Au, Pt, Al, Fe, Ti, Zn, alloys thereof, and stainless steel. The positive electrode collector foil 16 may have a coating layer for adjusting an electric resistance on a surface thereof. For example, the coating layer is a carbon coating.

A thickness of the positive electrode collector foil 16 is not particularly limited, but is, for example, preferably 0.1μm to 1mm and more preferably 1μm to 100μm.

Here, as can be seen from FIG. 1, the positive electrode collector foil 16 is configured such that an end surface thereof is disposedinward of the end surface of the positive electrode composite material layer 15. As a result, the positive electrode collector foil 16 is not exposed, and the occurrence of a large-scale short circuit can be suppressed as will be described later. A distance from the end surface of the positive electrode composite material layer 15 to the end surface of the positive electrode collector foil 16 indicated by T in FIG. 1 is not particularly limited, but is preferably 2mm or less. In a case where the distance is too large, the end part is likely to be chipped.

In addition, the end surface of the positive electrode collector foil 16 may be covered with the positive electrode composite material layer 15 as shown in FIG. 1, or may not be covered with the positive electrode composite material layer 15.

### Resin Layer

The resin layer 20 is a layer formed of a resin. The resin forming the resin layer is not particularly limited, and examples thereof include polyethylene and polypropylene.

As can be seen from FIG. 1, in the resin layer 20, an end part thereof protrudes from the positive electrode composite material layer 15, and a surface on the separator 12 side is exposed.

In addition, a filler of a metal such as Ni may be dispersed in the resin to impart conductivity to the resin layer. However, the conductivity may be reduced only in a portion of the resin layer 20, in which the positive electrode composite material layer 15 is not laminated.

### Effects and the Like

According to the secondary battery of the present form, as shown in FIG. 2, even when foreign matter A is mixed and a first end of the foreign matter A penetrates the separator 12 and reaches the negative electrode composite material layer 13, a second end of the foreign matter A directly comes into contact with the resin layer 20 without touching the positive electrode collector foil 16. Therefore, the short circuit between the negative electrode composite material layer 13 and the positive electrode collector foil 16 can be prevented, and the occurrence of a large-scale short circuit can be suppressed.

Here, the description has been made using the bipolar type of secondary battery, but the present disclosure is not limited thereto and can be applied to a monopolar type of secondary battery. However, in the monopolar type of secondary battery, a tab for connecting to an external collector is required at least in a part thereof, and the end surface of the positive electrode collector foil cannot be disposed inward in the tab, and an exposed surface of the positive electrode collector foil facing the separator is formed. From such a viewpoint, the effect of the bipolar type of secondary battery is more remarkable compared to the effect of the monopolar type of secondary battery.

As a test example, in each test example, the temperature rise in a case where foreign matter consisting of Ni was mixed into the laminate, the first end of the foreign matter penetrated the separator and reached the negative electrode composite material layer, and the second end was in contact with a surface of the separator facing the negative electrode composite material layer to forcibly cause an internal short circuit was measured. Here, as the positive electrode active material of the positive electrode composite material layer, a Ni-Co-Mn-based oxide, as the positive electrode collector foil, an aluminum foil, as the negative electrode active material of the negative electrode composite material layer, carbon, as the negative electrode collector foil, Cu, and as the separator, polyethylene were applied. Each test example is as follows.

Test Example 1: Form shown in FIG. 2

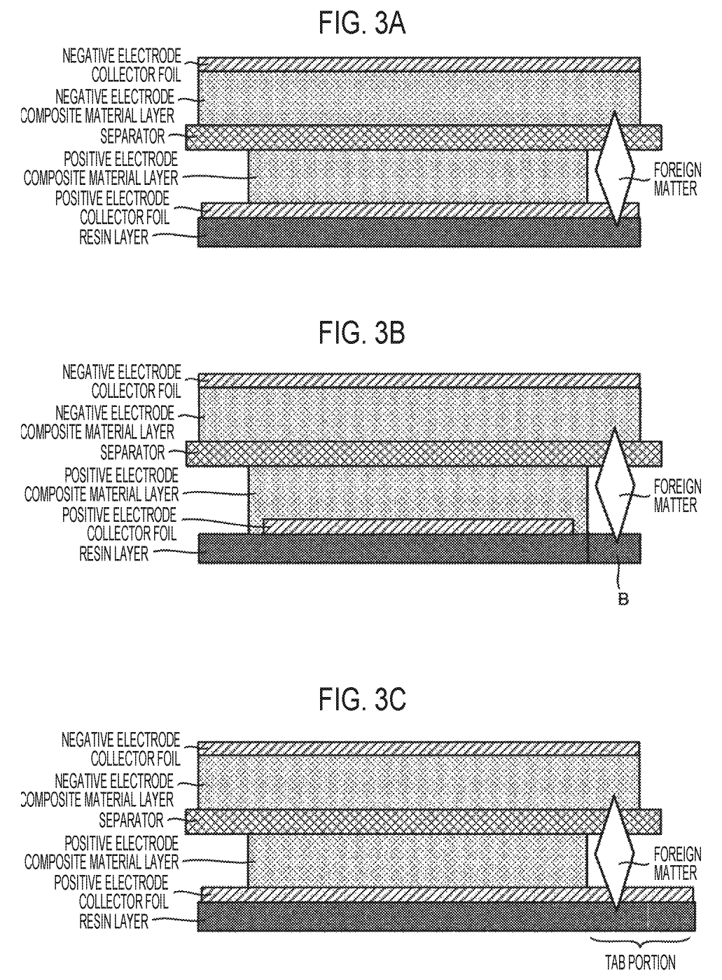

Test Example 2: Form in which end surface of positive electrode collector foil extends to end surface of resin layer (FIG. 3A)

Test Example 3: Form in which, in addition to the form shown in FIG. 2, a portion B of the resin layer, which protrudes from the positive electrode composite material layer, was made less conductive by not including a Ni filler (FIG. 3B)

Test Example 4: Monopolar type form with focus on tab portion

As a result, in Test Example 1, a temperature rise of 8° C was observed, in Test Example 2, a temperature rise of 50° C was observed, in Test Example 3, a temperature rise of 3° C was observed, and in Test Example 4, a temperature rise of 50° C was observed.

What is claimed is:

1. A secondary battery comprising a laminate that includes a separator and in which a negative electrode composite material layer and a negative electrode collector foil are laminated on a first surface of the separator, and a positive electrode composite material layer, a positive electrode collector foil, and a resin layer are laminated on a second surface of the separator, wherein:
an end surface of the positive electrode composite material layer is disposed inward of an end surface of the separator, an end surface of the negative electrode composite material layer, and an end surface of the resin layer; and
an end surface of the positive electrode collector foil is disposed inward of the end surface of the positive electrode composite material layer.

2. The secondary battery according to claim 1, wherein the laminate is a bipolar type.

3. The secondary battery according to claim 1, wherein a portion of an end part of the resin layer, the portion being not laminated with the positive electrode composite material layer, does not include a conductive filler.

4. The secondary battery according to claim 1, wherein a distance between the end surface of the positive electrode composite material layer and the end surface of the positive electrode collector foil is 2mm or less.
